(19) United States
(12) Patent Application Publication
(10) Pub. No.: US 2016/0356207 A1
(43) Pub. Date: Dec. 8, 2016

(54) Exhaust Tract For An Internal Combustion Engine

(71) Applicant: MAN TRUCK & BUS AG, Munchen (DE)

(72) Inventor: Pierre MENARD, Nurnberg (DE)

(21) Appl. No.: 15/174,294

(22) Filed: Jun. 6, 2016

(30) Foreign Application Priority Data
Jun. 6, 2015 (DE) 102015007414.8

(51) Int. Cl. F02B 37/18

(52) U.S. Cl. CPC F02B 37/183; F01N 2340/06

(57) ABSTRACT

An exhaust tract for an internal combustion engine, having an exhaust turbine having a housing and a turbine flow duct, into which exhaust gas flow coming from the engine flows, a wastegate, by which a proportion of the exhaust gas can bypass the turbine rotor, the turbine flow duct ducting the exhaust gas flow via the turbine rotor, and the wastegate on a discharge side of the exhaust turbine. The exhaust turbine-side outlet chamber is subdivided into a first exhaust turbine-side turbine exhaust gas flow inlet area, into which the exhaust gas flow coming from the turbine rotor flows, and a second exhaust turbine-side wastegate exhaust gas flow inlet area flow-separated from the first inlet area. A wastegate flow duct is provided adjoining the wastegate exhaust gas flow inlet area downstream of where the turbine exhaust gas flow inlet area opens.

### BACKGROUND OF THE INVENTION

1. Field of the Invention

The invention relates to an exhaust tract for an internal combustion engine, a method for the operation of the exhaust, and an internal combustion engine having the exhaust tract and/or for performing the method.

2. Description of the Related Art

The provision of an exhaust turbocharger in an internal combustion engine is known. Such an exhaust turbocharger comprises an exhaust turbine arranged in an exhaust tract and having a turbine flow duct, which serves for ducting an exhaust gas flow flowing into the exhaust turbine via a turbine rotor of the exhaust turbine. This flow drives the turbine rotor of the exhaust turbocharger and a compressor wheel of the exhaust turbocharger connected to the turbine rotor. The compressor wheel then compresses the combustion air delivered to the internal combustion engine.

Also known is the provision of a wastegate or a wastegate valve on the exhaust turbine, by which at least a proportion of the exhaust gas flow flowing into the exhaust turbine can be made to bypass the turbine rotor. The wastegate valve serves, for example, for setting or adjusting the compression or charge-air pressure of the combustion air. Here the wastegate valve is usually automatically regulated or controlled by a regulating and/or control device.

In addition, the turbine flow duct ducting the exhaust gas flow via the turbine rotor, and the wastegate on a discharge side of the exhaust turbine open into an exhaust turbine-side outlet chamber. This outlet chamber is of such a large volume that it results in a large increase in the cross section of the turbine flow duct and a highly turbulent exhaust gas flow in the outlet chamber. This highly turbulent exhaust gas flow causes an increased exhaust gas pressure downstream of the turbine rotor of the exhaust turbine, viewed in the exhaust gas flow direction, which has a negative effect on the compression performance of the exhaust turbo-charger.

### SUMMARY OF THE INVENTION

An object of the invention is therefore to provide an exhaust tract for an internal combustion engine and a method for the operation of an exhaust tract, in which the compression performance of the exhaust turbocharger is increased.

According to one aspect of the invention, an exhaust tract for an internal combustion engine is proposed, having an exhaust turbine, in particular an exhaust turbine of an exhaust turbocharger, arranged in the exhaust tract, the exhaust turbine having an exhaust turbine housing and comprising a turbine flow duct, into which an exhaust gas flow coming from the internal combustion engine flows and in which a turbine rotor of the exhaust turbine, driven by the exhaust gas flow, is arranged, the exhaust turbine further comprising a wastegate, by which a proportion of the exhaust gas flow flowing into the exhaust turbine can be made to bypass the turbine rotor as a wastegate exhaust gas flow, the turbine flow duct ducting the exhaust gas flow via the turbine rotor, and the wastegate on a discharge side of the exhaust turbine opening into an exhaust turbine-side outlet chamber, and a discharge duct, via which an exhaust gas flow coming from the turbine rotor and/or the wastegate exhaust gas flow fed via the wastegate flows out, adjoining the discharge side of the exhaust turbine. According to one aspect of the invention the exhaust turbine-side outlet chamber is subdivided into a first exhaust turbine-side turbine exhaust gas flow inlet area, into which the exhaust gas flow coming from the turbine rotor flows and which is adjoined by the discharge duct, and a second exhaust turbine-side wastegate exhaust gas flow inlet area, which is flow-separated from the first inlet area and into which the exhaust gas flow fed via the wastegate flows. Moreover, a wastegate flow duct is provided adjoining the wastegate exhaust gas flow inlet area, which downstream of the turbine exhaust gas flow inlet area opens, in particular tangentially, into the adjoining discharge duct, in such a way that the wastegate exhaust gas flow introduced into the discharge duct via the wastegate flow duct flows through the discharge duct as a peripheral flow on the inside wall of the discharge duct and spirally around a central longitudinal axis of the discharge duct in the direction away from the exhaust turbine.

This is a simple way of increasing the compression performance of the exhaust turbo-charger, since due to the subdivision or splitting of the outlet chamber and due to the spiral peripheral flow of the wastegate exhaust gas flow through the discharge duct, the exhaust gas pressure downstream of the turbine rotor (viewed in the exhaust gas flow direction) is significantly reduced. An especially energy-efficient exhaust gas ducting is therefore achieved by the exhaust tract according to one aspect of the invention.

The term “wastegate” is taken to mean any type of bypass duct provided on the exhaust turbine or bypass aperture provided on the exhaust turbine, by which the exhaust gas flow can be made to bypass the turbine rotor and which can be at least partially opened and closed by an actuating device.

In principle the actuating device may be of any design. For example, the actuating device may be formed in such a way that the bypass aperture is opened and closed automatically as a function of the exhaust gas pressure inside the exhaust turbine. It is preferred, however, if the actuating device is formed by a valve element, which can be regulated or controlled by a regulating and/or control device and which serves for opening and closing the bypass aperture.

In a preferred development of the exhaust tract according to one aspect of the invention the discharge duct directly adjoins the exhaust turbine-side turbine exhaust gas flow inlet area, in such a way that the exhaust gas flow coming from the turbine rotor flows through the discharge duct in the direction of the central longitudinal axis of the discharge duct away from the exhaust turbine. In this way the exhaust gas pressure is further reduced downstream of the turbine rotor of the exhaust turbine, viewed in the exhaust gas flow direction. Moreover, the mixing of the exhaust gas flow coming from the turbine rotor with the wastegate exhaust gas flow is also improved.

The coordinated outlet apertures of the exhaust turbine-side turbine exhaust gas flow inlet area and of the adjoining discharge duct are preferably of substantially identical design, in order to further reduce the exhaust gas pressure downstream of the turbine rotor of the exhaust turbine, viewed in the exhaust gas flow direction. Here the coordinated outlet apertures of the exhaust turbine-side turbine exhaust gas flow inlet area and of the adjoining discharge duct preferably align with one another. This is a simple and reliable way of ensuring that the exhaust gas flow coming from the turbine rotor flows through the discharge duct in the direction of the central longitudinal axis of the discharge duct away from the exhaust turbine.

The cross sectional area, preferably the diameter, of the wastegate flow duct is preferably less than the cross sectional area, preferably the diameter, of the discharge duct, at least in the area where it opens into the discharge duct. This ensures that the exhaust gas flow coming from the turbine rotor and the wastegate exhaust gas flow have a similar velocity, at least in the area where the wastegate flow duct opens into the discharge duct. This further reduces the exhaust gas pressure downstream of the turbine rotor of the exhaust turbocharger, viewed in the exhaust gas flow direction.

The wastegate flow duct, relative to a cross section through the discharge duct, also preferably tangentially and/or eccentrically adjoins an outer wall portion of the discharge duct, preferably in such a way that an outer (relative to the cross section) and straight outlet-side duct wall portion of the wastegate flow duct lies approximately at the level of an apex of the discharge duct. This is a simple way of ensuring that the wastegate exhaust gas flow introduced into the discharge duct flows as a spiral peripheral flow on the inside wall of the discharge ducts. The outlet-side duct wall portion of the wastegate flow duct here preferably merges continuously into the discharge duct, that is to say without any step, edge or the like, in order to prevent a heavy turbulence of the wastegate exhaust gas flow introduced into the discharge duct.

A central longitudinal axis of the wastegate flow duct is preferably situated at a defined distance from the apex of the discharge duct, preferably a distance which is approximately equal to between one third and two thirds, preferably about half, of the diameter of the wastegate flow duct in the outlet area of the wastegate flow duct where it opens into the discharge duct.

The wastegate-flow duct furthermore preferably opens angularly into the discharge duct in such a way that an angle between at least the outlet-side area of the wastegate flow duct and hence the wastegate exhaust gas flow flowing into the discharge duct on the one hand, and a cross sectional plane, formed by the cross section of the discharge duct in the outlet area and/or oriented transversely to the longitudinal axis of the discharge duct in the outlet area of the wastegate flow duct on the other, ranges from 30° to 80°, preferably from 40° to 80°, more preferably from 45° to 80°. This angling reliably ensures that the wastegate exhaust gas flow introduced into the discharge duct flows through the discharge duct away from the exhaust turbine. A larger angle between the wastegate exhaust gas flow and the cross sectional plane here reduces the exhaust gas pressure downstream of the turbine rotor of the exhaust turbine, viewed in the exhaust gas flow direction.

In a preferred development the discharge duct has a round, in particular a circular cross section. This is a simple and reliable way of achieving the spiral peripheral flow of the wastegate exhaust gas flow introduced into the discharge duct through the discharge duct.

The cross section of the discharge duct is preferably substantially constant along the exhaust manifold flow duct, to achieve a harmonious mixing of the exhaust gas flow coming from the turbine and the wastegate exhaust gas flow in the discharge duct. Moreover, this further reduces the exhaust gas pressure downstream of the turbine rotor of the exhaust turbine, viewed in the exhaust gas flow direction.

The cross section of the wastegate flow duct downstream of the wastegate is more preferably larger than the maximum aperture cross section of the wastegate aperture of the wastegate. This prevents the wastegate exhaust gas flow downstream of the wastegate, viewed in the exhaust gas flow direction, from accumulating in the wastegate flow duct. Such an accumulation or a high exhaust gas pressure downstream of the wastegate, viewed in the exhaust gas flow direction, significantly reduces the efficiency of the wastegate.

The exhaust turbine-side exhaust gas flow inlet area on the discharge side of the exhaust turbine is preferably separated from the exhaust turbine-side wastegate exhaust gas flow inlet area by at least one dividing wall provided on the outlet chamber side, to ensure a reliable division of the outlet chamber.

In a preferred development the discharge duct is formed by a separate component, which is connected to the exhaust turbine or to an exhaust turbine housing. The exhaust tract according to the invention thereby has an especially simple construction. It is preferred here that the exhaust turbine and the separate component be connected to one another by a flange connection, in order to afford a simple and reliable connection between the exhaust turbine and the separate component.

The separate component more preferably forms the wastegate-flow duct, in order to simplify the construction of the exhaust tract according to one aspect of the invention.

A method is furthermore proposed for the operation of an exhaust tract for an internal combustion engine, having an exhaust turbine, in particular an exhaust turbine of an exhaust turbocharger, arranged in the exhaust tract, the exhaust turbine having an exhaust turbine housing and comprising a turbine flow duct, into which an exhaust gas flow coming from the internal combustion engine flows and in which a turbine rotor of the exhaust turbine, driven by the exhaust gas flow, is arranged, the exhaust turbine further comprising a wastegate, by which a proportion of the exhaust gas flow flowing into the exhaust turbine can be made to bypass the turbine rotor as a wastegate exhaust gas flow, the turbine flow duct ducting the exhaust gas flow via the turbine rotor, and the wastegate on a discharge side of the exhaust turbine opening into an exhaust turbine-side outlet chamber, and a discharge duct, via which an exhaust gas flow coming from the turbine rotor and/or the wastegate exhaust gas flow fed via the wastegate flows out, adjoining the discharge side of the exhaust turbine. According to the invention the exhaust turbine-side outlet chamber is subdivided into a first exhaust turbine-side turbine exhaust gas flow inlet area, into which the exhaust gas flow coming from the turbine rotor flows and which is adjoined by the discharge duct, and a second exhaust turbine-side wastegate exhaust gas flow inlet area, which is flow-separated from the first inlet area and into which the exhaust gas flow fed via the wastegate flows. Moreover, a wastegate flow duct is provided adjoining the wastegate exhaust gas flow inlet area, which downstream of the turbine exhaust gas flow inlet area opens, in particular tangentially, into the adjoining discharge duct, such that the wastegate exhaust gas flow introduced into the discharge duct via the wastegate flow duct flows through the discharge duct as a peripheral flow on the inside wall of the discharge duct and spirally around a central longitudinal axis of the discharge duct in the direction away from the exhaust turbine.

The advantages accruing from the method according to the invention are identical to the already acknowledged advantages of the exhaust tract according to the invention, so that these advantages will not be repeated at this juncture.

In addition, an internal combustion engine having the exhaust tract according to the invention and/or for performing the method according to the invention is also claimed. The advantages accruing are likewise identical to the already acknowledged advantages of the exhaust tract according to the invention, so that these advantages will not be repeated here either. Here the internal combustion engine may be embodied, for example, as a vehicle internal combustion engine or as a fixed internal combustion engine.

The advantageous embodiments and/or developments of the invention explained above and/or described in the dependent claims may be applied individually or also in any combination with one another, except in cases of clear dependencies or incompatible alternatives, for example.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and advantageous embodiments and/or developments thereof together with the advantages of these are explained in more detail below, referring to drawings and merely by way of example.

In the drawings:

FIG. 1 is a perspective representation of a part of an exhaust tract;

FIG. 2 is a sectional representation of a part of the exhaust tract;

FIG. 3 is a schematic representation of a part of the exhaust tract;

FIG. 4 is a schematic, sectional representation of an exhaust tract element of the exhaust tract; and

FIG. 5 is an exhaust tract according to the prior art.

### DETAILED DESCRIPTION OF THE PRESENTLY PREFERRED EMBODIMENTS

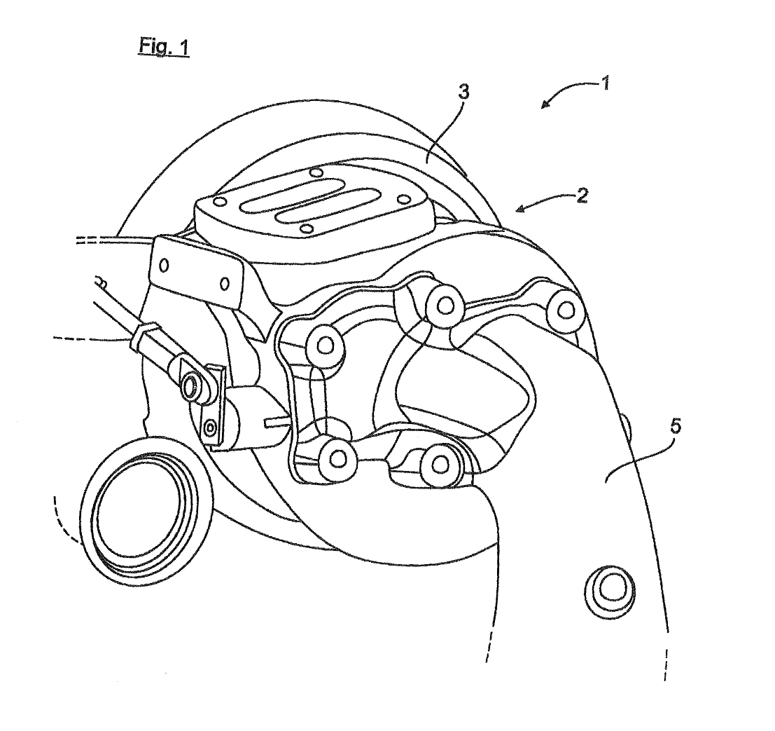

FIG. 1 shows a part of an exhaust tract 1 according to the invention of an internal combustion engine. The exhaust tract 1 comprises an exhaust turbine 3 of an exhaust turbocharger 2 and an exhaust pipe or exhaust tract element 5 arranged downstream of the exhaust turbine 3, viewed in the exhaust gas flow direction, and connected to the exhaust turbine 3. Here the exhaust turbine 3 and the exhaust tract element 5 are connected to one another, for example, by a flange connection. Alternatively, however, the exhaust turbine 3 and the exhaust tract element 5 could also be connected to one another by a cohesive material joint and/or integrally formed.

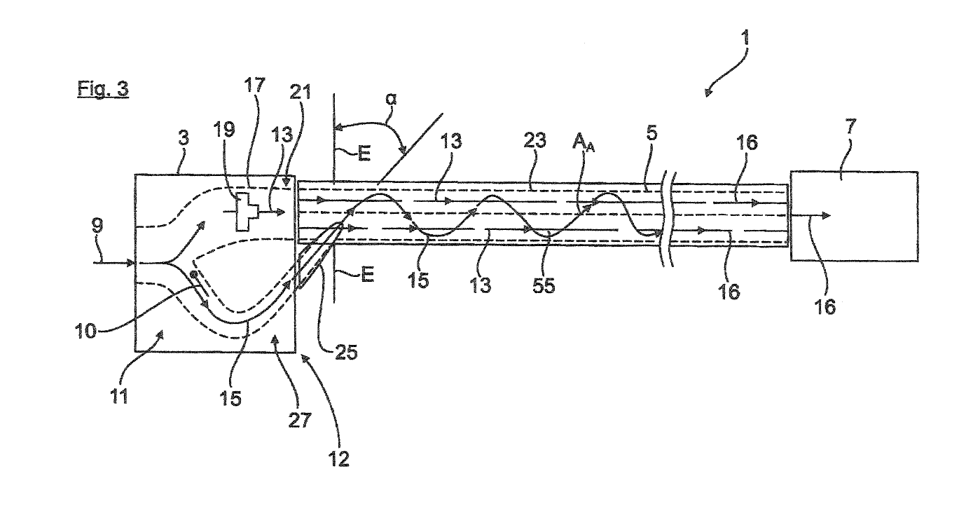

According to FIG. 3, in the operation of the internal combustion engine an exhaust gas flow 9 coming from the internal combustion engine flows into the exhaust turbine 3. Provided that a wastegate 11 or a wastegate valve 10 of the exhaust turbine 3 is at least partially opened, the exhaust gas flow 9 flowing through the exhaust turbine 3 is divided into a turbine rotor exhaust gas flow 13 and a wastegate exhaust gas flow 15. The turbine rotor exhaust gas flow 13 flows through a turbine flow duct 17 of the exhaust turbine 3, by which the turbine rotor exhaust gas flow 13 is ducted via a turbine rotor 19 of the exhaust turbine 3 arranged in the turbine flow duct 17. The wastegate exhaust gas flow 15 in this case flows through the wastegate 11, by which the wastegate exhaust gas flow 15 is made to bypass the turbine rotor 19 of the exhaust turbocharger 3.

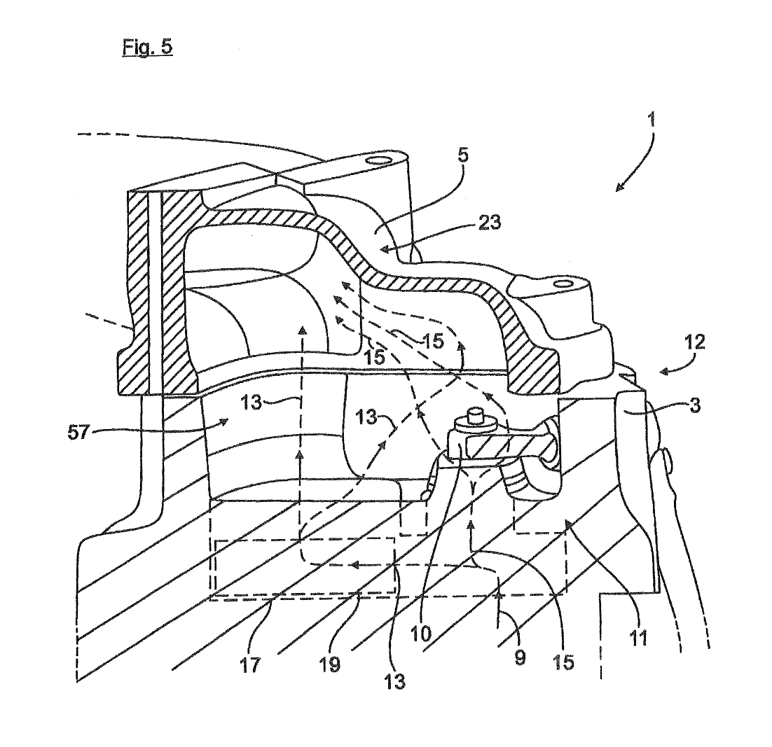

FIG. 5 shows a section through an exhaust tract 1 according to the prior art. The turbine rotor flow duct 17 and the wastegate 10 here open into a large-volume outlet chamber 57 of the exhaust turbine 3 on a discharge side 12 of the exhaust turbine 3. This gives rise to a high exhaust gas pressure downstream of the turbine rotor 19 of the exhaust turbocharger 3, viewed in the exhaust gas flow direction, which has a negative effect on the compression performance of the exhaust turbocharger 3.

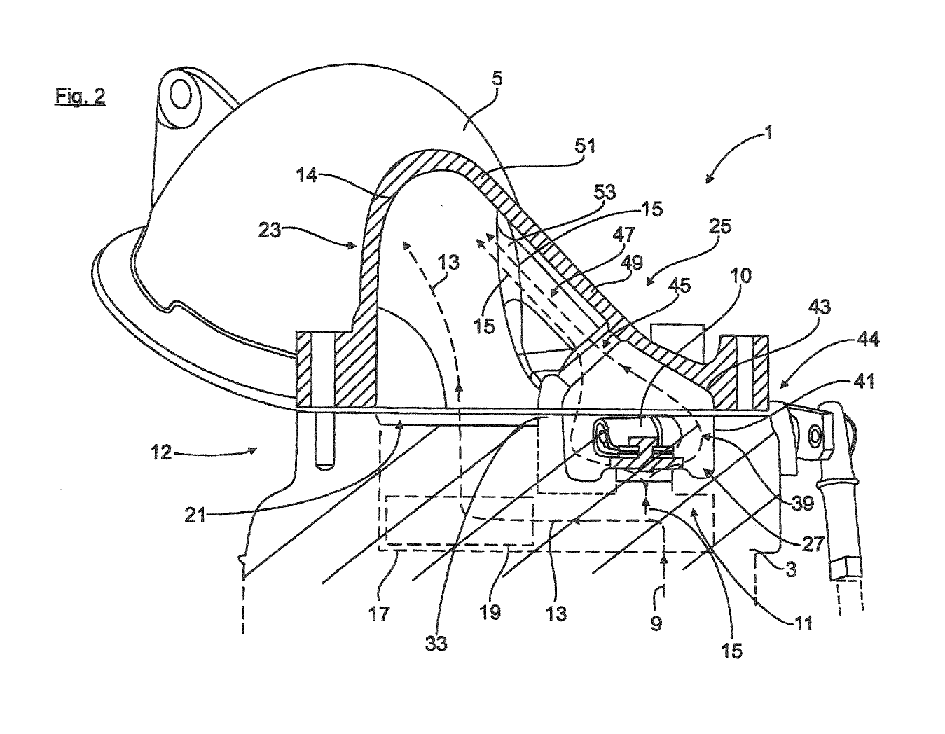

In contrast to the prior art shown in FIG. 5, in the exhaust tract 1 according to the invention, as shown in FIG. 2, the outlet chamber 57 is divided into a first exhaust turbine-side turbine exhaust gas flow inlet area 21, and a second exhaust turbine-side wastegate exhaust gas flow inlet area 27 flow-separated from the first inlet area 21. The exhaust gas flow 13 coming from the turbine rotor 19 flows into the first inlet area 21. A discharge duct 23 of the exhaust pipe 5 moreover adjoins the first inlet area 21, so that the turbine rotor exhaust gas flow 13 coming from the turbine rotor 19 flows into the discharge duct 23 via the first inlet area 21. The exhaust gas flow 15 fed via the wastegate 11 flows into the second inlet area 27. Here, for example, the exhaust turbine-side turbine exhaust gas flow inlet area 21 is separated from the exhaust turbine-side wastegate exhaust gas flow inlet area 27 by a dividing wall 33 provided on the outlet chamber-side.

According to FIG. 3 a wastegate-flow duct 25, which opens into the adjoining discharge duct 23 downstream of the turbine exhaust gas flow inlet area 21, adjoins the wastegate exhaust gas flow inlet area 27, in such a way that the wastegate exhaust gas flow 15 introduced into the discharge duct 23 via the wastegate 11 and the wastegate exhaust gas flow inlet area 27 flows through the discharge duct 23 as a peripheral flow on an inside wall 14 of the discharge duct 23 and spirally around a central longitudinal axis AA of the discharge duct 23 in a direction away from the exhaust turbine 3. In this way, the exhaust gas pressure downstream of the turbine rotor 19 of the exhaust turbine 3, viewed in the exhaust gas flow direction, is significantly reduced compared to the prior art. Here the wastegate-flow duct 25 is formed on the exhaust tract element 5, for example.

Downstream of where the wastegate flow duct 25 opens into the discharge duct 23, viewed in the exhaust gas flow direction, the turbine exhaust gas flow 13 and the wastegate exhaust gas flow 15 mix in the discharge duct 23 to form a mixed exhaust gas flow 16. Here the mixed exhaust gas flow 16 flows, for example, into an exhaust tract portion 7, arranged downstream of the exhaust tract element 5, viewed in the exhaust gas flow direction, and connected to the exhaust tract element 5. The exhaust tract portion 7 may comprise, for example, multiple exhaust gas after treatment elements, for example an SCR catalytic converter or a particle filter.

As is shown in FIG. 2, the coordinated outlet apertures of the exhaust turbine-side turbine exhaust gas flow inlet area 21 and the adjoining discharge duct 23 here are of similar or identical design, for example. Moreover, the coordinated outlet apertures of the exhaust turbine-side turbine exhaust gas flow inlet area 21 and the adjoining discharge duct 23 are arranged in alignment with one another, for example. This is a particularly reliable way of ensuring that, as is shown in FIG. 3, the exhaust gas flow 13 coming from the turbine rotor 19 flows through the discharge duct 23 in the direction of the central longitudinal axis AA of the discharge duct 23 away from the exhaust turbine 3.

As is shown by way of example according to FIG. 3, the cross sectional area of the wastegate flow duct 25 in the area where it opens into the discharge duct 23 is furthermore smaller than the cross sectional area of the discharge duct 23. As a result, the turbine rotor exhaust gas flow 13 and the wastegate exhaust gas flow 15 in the area where the wastegate flow duct 25 opens into the discharge duct 23 have a similar velocity.

As is further shown in FIG. 3, the wastegate-flow duct 25 opens into the discharge duct 23 at such an angle, for example, that in the area where the wastegate flow duct 25 opens into the discharge duct 23 an angle α between the wastegate exhaust gas flow 15 flowing into the discharge duct 23 and a cross sectional plane E, formed by the cross section of the discharge duct 23 in the outlet area and oriented transversely to the longitudinal axis of the discharge duct 23 in the outlet area of the wastegate flow duct 25, assumes a value here of just 45°, for example. By this angle an especially low exhaust gas pressure is achieved downstream of the turbine rotor 19 of the exhaust turbine 3, viewed in the exhaust gas flow direction.

The exhaust manifold flow duct 23 here furthermore has a round cross section, for example. The cross section of the exhaust manifold flow duct 23 here is moreover substantially constant along the exhaust manifold flow duct 23.

As FIG. 2 shows, a duct portion 39 forming the wastegate exhaust gas flow inlet area 27 has an annular cross sectional contour, for example. Furthermore, the cross section of the duct portion 39 here is substantially constant along the duct portion 39, for example. In addition, a duct wall 41 defining the wastegate-flow duct 25 here merges continuously into a duct wall 43 defining the duct portion 39, for example. Downstream of a connecting area 44, viewed in the exhaust gas flow direction, where the exhaust turbine 3 and the exhaust tract element 5 are connected to one another, the cross section of the wastegate flow duct 25 tapers up to a duct portion 45 wastegate flow duct 25, for example. The duct portion 45 here forms the smallest cross section of the wastegate-flow duct 25. The duct portion 45 here, for example, has a constant cross section over its entire length. The cross section of the duct portion 45 here is greater, for example, than the maximum aperture cross section wastegate 11 or the wastegate valve 10.

Furthermore, adjoining the duct portion 45 here is a connection duct portion 47 of the waste-gate flow duct 25. A duct wall 49 defining the connection duct portion 47 here merges continuously into the exhaust manifold duct wall 29, for example. This continuous transition is achieved here by a rounding 53, for example.

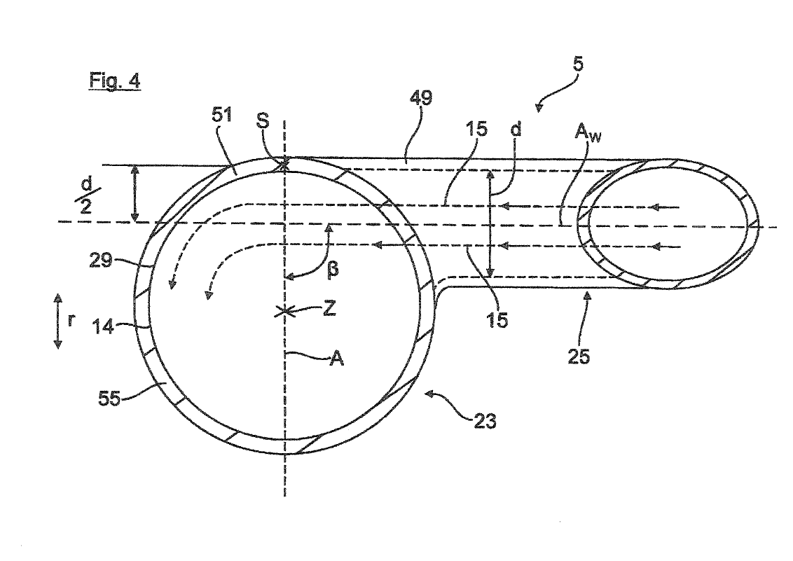

FIG. 4 shows a schematic cross section through the exhaust tract element 5. This representation is intended to illustrate that the wastegate-flow duct 25 here tangentially and eccentrically adjoins an outer wall portion 51 of the discharge duct 23, viewed in the discharge duct radial direction r, in such a way that in the area where the wastegate flow duct 25 opens into the discharge duct 23, a straight, outer duct wall portion 49 of the wastegate flow duct 25, viewed in the discharge duct radial direction r, here lies at the level of an upper apex S of the discharge duct 23, for example. This is an especially reliable way of ensuring that the wastegate exhaust gas flow 15 flowing into the discharge duct 23 flows as a spiral peripheral flow on the inside wall 14 of the discharge duct 23. Moreover, the outer wall portion 51 of the discharge duct 23 here also merges continuously into the duct wall portion 49 of the wastegate flow duct 25, for example. The apex S could obviously also lie at any other point on the outer circumference; in this respect the representation here is to be interpreted only schematically and by way of example.

In addition, a central longitudinal axis AW of the wastegate flow duct 25 here in the area where the wastegate flow duct 25 opens into the discharge duct 23, for example, is situated at a distance from the apex S of the discharge duct 23, which is preferably approximately equal to half a diameter d of the wastegate flow duct 25 in the outlet area, for example. Furthermore, an angle 13 between the central longitudinal axis AW of the wastegate flow duct 25 and an axis A here assumes a value of 90°, for example. The axis A runs through the apex S and a central point Z, through which the longitudinal axis AA of the discharge duct 23 runs.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An exhaust tract for an internal combustion engine comprising:
an exhaust turbine of an exhaust turbocharger arranged in the exhaust tract and having an exhaust turbine housing and comprising a turbine flow duct, into which an exhaust gas flow coming from the internal combustion engine flows
a turbine rotor of the exhaust turbine, driven by the exhaust gas flow arranged in the turbine flow duct,
a wastegate by which a proportion of the exhaust gas flow flowing into the exhaust turbine can be made to bypass the turbine rotor as a wastegate exhaust gas flow,
an exhaust turbine-side outlet chamber subdivided into a first exhaust turbine-side turbine exhaust gas flow inlet area and a second exhaust turbine-side wastegate exhaust gas flow inlet area flow-separated from the first inlet area and into which the turbine flow duct ducting the exhaust gas flow via the turbine rotor and the wastegate on a discharge side of the exhaust turbine open;
a discharge duct adjoining the discharge side of the exhaust turbine and via which an exhaust gas flow from at least one of the turbine rotor and the wastegate exhaust gas flow fed via the wastegate flows out, wherein:
the first exhaust turbine-side turbine exhaust gas flow inlet area adjoins the discharge duct and into which the exhaust gas flow coming from the turbine rotor flows, and
the second exhaust turbine-side wastegate exhaust gas flow inlet area is configured to receive the exhaust gas flow fed via the wastegate; and
a wastegate flow duct arranged adjoining the wastegate exhaust gas flow inlet area, down-stream of the turbine exhaust gas flow inlet area, tangentially into the adjoining discharge duct such that the wastegate exhaust gas flow introduced into the discharge duct via the wastegate flow duct flows through the discharge duct as a peripheral flow on an inside wall of the discharge duct and spirally around a central longitudinal axis of the discharge duct away from the exhaust turbine.

2. The exhaust tract according to claim 1, wherein the discharge duct directly adjoins the exhaust turbine-side turbine exhaust gas flow inlet area, such that the exhaust gas flow from the turbine rotor flows through the discharge duct in a direction of the central longitudinal axis of the discharge duct away from the exhaust turbine.

3. The exhaust tract according to claim 2, wherein outlet apertures of the exhaust turbine-side turbine exhaust gas flow inlet area and of the adjoining discharge duct are of substantially identical design, the outlet apertures of the exhaust turbine-side turbine exhaust gas flow inlet area and of the adjoining discharge duct aligned with one another.

4. The exhaust tract according to claim 1, wherein a cross sectional area of the wastegate flow duct is less than a cross sectional area of the discharge duct at least in an area where it opens into the discharge duct.

5. The exhaust tract according to claim 1, wherein the wastegate-flow duct, relative to a cross section through the discharge duct one of tangentially and eccentrically adjoins an outer wall portion of the discharge duct, such that an outer outlet-side duct wall portion of the wastegate flow duct lies substantially at a level of an apex of the discharge duct, and merges continuously into the discharge duct.

6. The exhaust tract according to claim 5, wherein a central longitudinal axis of the wastegate flow duct is situated at a defined distance from the apex of the discharge duct.

7. The exhaust tract according to claim 1, wherein the wastegate-flow duct opens angularly into the discharge duct forming an angle between the outlet-side area of the wastegate flow duct and the wastegate exhaust gas flow flowing into the discharge duct, and a cross sectional plane, formed by a cross section of the discharge duct in one of the outlet area and oriented transversely to longitudinal axis of the discharge duct in the outlet area of the wastegate flow duct on the other, the angle ranging from 30° to 80°.

8. The exhaust tract according claim 1, wherein the discharge duct has a round cross section.

9. The exhaust tract according to claim 8, wherein the round cross section of the discharge duct is substantially constant along the discharge duct.

10. The exhaust tract according to claim 1, wherein a cross section of the wastegate flow duct downstream of the wastegate is larger than a maximum aperture cross section of a wastegate aperture of the wastegate.

11. The exhaust tract according claim 1, wherein the exhaust turbine-side exhaust gas flow inlet area on the discharge side of the exhaust turbine is separated from the exhaust turbine-side wastegate exhaust gas flow inlet area by at least one dividing wall provided on an outlet chamber side.

12. The exhaust tract according to claim 1, wherein the discharge duct is a separate component connected to one of the exhaust turbine and an exhaust turbine housing.

13. A method for operation of an exhaust tract for an internal combustion engine having an exhaust turbine of an exhaust turbocharger arranged in the exhaust tract, comprising:
an exhaust gas flow coming from the internal combustion engine flows in a turbine flow duct of the exhaust turbine, the exhaust turbine having an exhaust turbine housing in which a turbine rotor of the exhaust turbine, driven by the exhaust gas flow, is arranged;
a proportion of the exhaust gas flow flowing into the exhaust turbine can be made to bypass the turbine rotor as a wastegate exhaust gas flow the exhaust turbine via a wastegate;
wherein the turbine flow duct ducting the exhaust gas flow via the turbine rotor, and the wastegate arranged on a discharge side of the exhaust turbine open into an exhaust turbine-side outlet chamber, and
wherein a discharge duct, via which an exhaust gas flow coming from at least one of the turbine rotor and the wastegate exhaust gas flow fed via the wastegate flows out, adjoins the discharge side of the exhaust turbine,
subdividing the exhaust turbine-side outlet chamber into a first exhaust turbine-side turbine exhaust gas flow inlet area, into which the exhaust gas flow coming from the turbine rotor flows adjoins the discharge duct, and a second exhaust turbine-side wastegate exhaust gas flow inlet area, which is flow-separated from the first inlet area and into which the exhaust gas flow fed via the wastegate flows, and
providing a wastegate flow duct adjoining the wastegate exhaust gas flow inlet area, which downstream of the turbine exhaust gas flow inlet area opens, in particular tangentially, into the adjoining discharge duct, such that the wastegate exhaust gas flow introduced into the discharge duct via the wastegate flow duct flows through the discharge duct as a peripheral flow on an inside wall of the discharge duct and spirally around a central longitudinal axis of the discharge duct in a direction away from the exhaust turbine.

14. An internal combustion engine comprising:
an exhaust tract for an internal combustion engine comprising:
an exhaust turbine of an exhaust turbocharger arranged in the exhaust tract and having an exhaust turbine housing and comprising a turbine flow duct, into which an exhaust gas flow coming from the internal combustion engine flows
a turbine rotor of the exhaust turbine, driven by the exhaust gas flow arranged in the turbine flow duct,
a wastegate by which a proportion of the exhaust gas flow flowing into the exhaust turbine can be made to bypass the turbine rotor as a wastegate exhaust gas flow,
an exhaust turbine-side outlet chamber subdivided into a first exhaust turbine-side turbine exhaust gas flow inlet area and a second exhaust turbine-side wastegate exhaust gas flow inlet area flow-separated from the first inlet area and into which the turbine flow duct ducting the exhaust gas flow via the turbine rotor and the wastegate on a discharge side of the exhaust turbine open;
a discharge duct adjoining the discharge side of the exhaust turbine and via which an exhaust gas flow from at least one of the turbine rotor and the wastegate exhaust gas flow fed via the wastegate flows out, wherein:
the first exhaust turbine-side turbine exhaust gas flow inlet area adjoins the discharge duct and into which the exhaust gas flow coming from the turbine rotor flows, and
the second exhaust turbine-side wastegate exhaust gas flow inlet area is configured to receive the exhaust gas flow fed via the wastegate; and
a wastegate flow duct arranged adjoining the wastegate exhaust gas flow inlet area, down-stream of the turbine exhaust gas flow inlet area, tangentially into the adjoining discharge duct such that the wastegate exhaust gas flow introduced into the discharge duct via the wastegate flow duct flows through the discharge duct as a peripheral flow on an inside wall of the discharge duct and spirally around a central longitudinal axis of the discharge duct away from the exhaust turbine.

15. The exhaust tract according to claim 6, wherein the defined distance from the apex of the discharge duct is substantially equal to between one and two thirds, of a diameter of the wastegate flow duct in the outlet area of the wastegate flow duct where it opens into the discharge duct.

16. The exhaust tract according to claim 12, wherein the separate component is connected to the one of the exhaust turbine and an exhaust turbine housing by a flange connection.
